(19) United States
(12) Patent Application Publication
(10) Pub. No.: US 2026/0158649 A1
(43) Pub. Date: Jun. 11, 2026

(54) SERVICE SUPPORT METHOD, SERVICE SUPPORT DEVICE, ROBOT, AND RECORDING MEDIUM

(71) Applicant: Panasonic Intellectual Property Management Co., Ltd., Osaka (JP)

(72) Inventors: Yuki KOTAKEHARA, Hyogo (JP); Shunsuke KUHARA, Osaka (JP); Toshiya ARAI, Osaka (JP)

(21) Appl. No.: 19/461,969

(22) Filed: Jan. 28, 2026

Related U.S. Application Data
(63) Continuation of application No. PCT/JP2024/027085, filed on Jul. 30, 2024.

(30) Foreign Application Priority Data
Aug. 9, 2023 (JP) 2023-130430

(51) Int. Cl. B25J 9/16; B25J 9/00

(52) U.S. Cl. CPC B25J 9/1661; B25J 9/0084; B25J 9/163

(57) ABSTRACT

A service support method is a service support method for supporting a service executed by a plurality of robots. The service support method includes: calculating a switched service-quality level indicating an overall quality of a quality of a first service and a quality of a second service when the first service is switched to the second service, the first service being executed by a predetermined robot among the plurality of robots; calculating a non-switched service-quality level indicating an overall quality of the quality of the first service and the quality of the second service when the first service executed by the predetermined robot is not switched to the second service; and outputting switching information related to switching of the service, based on the switched service-quality level and the non-switched service-quality level.

### CROSS REFERENCE TO RELATED APPLICATIONS

This is a continuation application of PCT International Application No. PCT/JP2024/027085 filed on Jul. 30, 2024, designating the United States of America, which is based on and claims priority of Japanese Patent Application No. 2023-130430 filed on Aug. 9, 2023. The entire disclosures of the above-identified applications, including the specifications, drawings and claims are incorporated herein by reference in their entirety.

### FIELD

The present disclosure relates to a service support method for supporting services executed by a plurality of robots, a service support device, a robot that executes services, and a recording medium.

### BACKGROUND

Conventional methods in which a plurality of robots execute a plurality of services are known. Patent Literature (PTL) 1 discloses a method for calculating a service effect for each of a plurality of robots when any service to be executed by a robot occurs, and causing the robot that provides the greatest service effect to execute the service.

### CITATION LIST

PTL 1: Japanese Patent No. 7051556

### SUMMARY

### Technical Problem

However, the method disclosed in PTL 1 may excessively increase the number of robots that execute particular services, leading to a reduction in overall quality of a plurality of services.

In view of the above, the present disclosure provides a service support method and the like that prevents a reduction in overall quality of a plurality of services executed by a plurality of robots.

### Solution to Problem

A service support method according to one aspect of the present disclosure is a service support method for supporting a service executed by a plurality of robots. The service support method includes: calculating a switched service-quality level indicating an overall quality of a quality of a first service and a quality of a second service when the first service is switched to the second service, the first service being executed by a predetermined robot among the plurality of robots; calculating a non-switched service-quality level indicating an overall quality of the quality of the first service and the quality of the second service when the first service executed by the predetermined robot is not switched to the second service; and outputting switching information related to switching of the service, based on the switched service-quality level and the non-switched service-quality level.

A service support device according to one aspect of the present disclosure is a service support device that supports a service executed by a plurality of robots. The service support device includes: a quality level calculator that calculates: a switched service-quality level indicating an overall quality of a quality of a first service and a quality of a second service when the first service is switched to the second service, the first service being executed by a predetermined robot among the plurality of robots; and a non-switched service-quality level indicating an overall quality of the quality of the first service and the quality of the second service when the first service executed by the predetermined robot is not switched to the second service; and a switching information outputter that outputs switching information related to switching of the service, based on the switched service-quality level and the non-switched service-quality level.

A robot according to one aspect of the present disclosure is the predetermined robot that communicates with the service support device described above. The robot operates based on the switching information output from the service support device.

A recording medium according to one aspect of the present disclosure is a non-transitory computer-readable recording medium having recorded thereon a program for causing a computer to execute the service support method described above.

It should be noted that these general and specific aspects according to the present disclosure may be implemented using a system, a method, an integrated circuit, a computer program, or a computer-readable recording medium such as a CD-ROM, or any combination of systems, methods, integrated circuits, computer programs, and recording media.

### Advantageous Effects

With the service support method and the like according to an aspect of the present disclosure, it is possible to prevent a reduction in overall quality of a plurality of services executed by a plurality of robots.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 illustrates an example of a plurality of services executed by a plurality of robots.

FIG. 2 illustrates an overall configuration of a service support system.

FIG. 3 is a block diagram illustrating a functional configuration of each robot and a service support device included in the service support system.

FIG. 4 is a schematic diagram of a robot that executes a service.

FIG. 5 illustrates examples of robot-related information obtained by the service support device.

FIG. 6 illustrates examples of service request information obtained by the service support device.

FIG. 7 illustrates trigger information stored in the service support device.

FIG. 8 illustrates coefficients and the like for deriving service quality levels.

FIG. 9 illustrates Operation Example 1 of robots and the service support device.

FIG. 10 illustrates Operation Example 2 of the robots and the service support device.

FIG. 11 is a flowchart of a service support method according to an embodiment.

FIG. 12 is a diagram for explaining a service support method according to Variation 1 of the embodiment.

FIG. 13 illustrates assignment candidates of services executed by the robots.

FIG. 14 is a diagram for explaining a service support method according to Variation 2 of the embodiment.

FIG. 15 illustrates examples of the services that are currently being executed by the robots.

FIG. 16 illustrates setting candidates for assignment of services to the robots.

FIG. 17 illustrates Operation Example 3 of the robots and the service support device.

FIG. 18 illustrates examples of a selection of a robot whose service is to be changed to inspection and security.

### DESCRIPTION OF EMBODIMENT

Conventional methods for executing a plurality of services using a plurality of robots are known. Here, as a comparative example, an example in which the service that is being executed by a predetermined robot is switched to another service will be described.

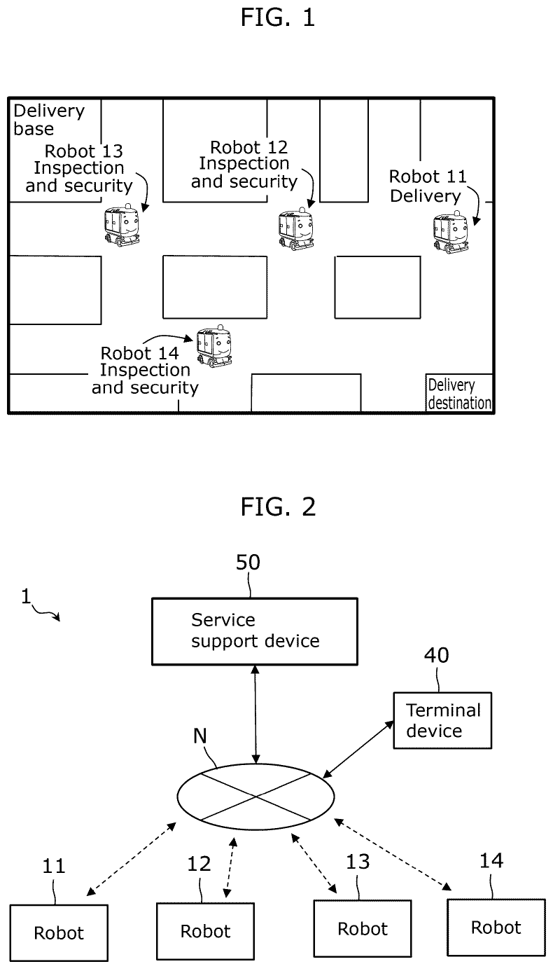

FIG. 1 illustrates an example of a plurality of services executed by a plurality of robots.

FIG. 1 illustrates an example in which the service that is currently being executed by robot 11 is delivery, and the service that is currently being executed by each of robots 12, 13 and 14 is inspection and security.

For example, in the comparison example, when some kind of service related to robot 11 occurs, service effect E of the robot alone when the service is switched and service effect E of the robot alone when the service is not switched are calculated to determine whether to switch the service. Service effect E is derived by (Expression 1) below.

$$E = a \times t 1 / ( t 0 + t 1 ) \qquad ( Expression 1 )$$

In (Expression 1), t0 is the travel time required for the robot to travel to the service execution position, and t1 is the execution time required for the robot to execute the service. α is a service parameter that is a value determined based on, for example, the service priority, whether the service is currently being executed, and whether an alternative service for the service that is being executed is available.

In the comparison example, when service effect E of robot 11 when the service is switched is higher than service effect E of robot 11 alone when the service is not switched, the service that is currently being executed by robot 11 is switched to another service. However, the method may excessively increase the number of robots that execute particular services, leading to a reduction in overall quality of the plurality of services.

The service support method and the like according to the present disclosure includes the following processes to prevent a reduction in overall quality of a plurality of services executed by a plurality of robots. Examples of the service support method and the like according to the present disclosure will be described below.

A service support method according to Example 1 is a service support method for supporting a service executed by a plurality of robots. The service support method includes: calculating a switched service-quality level indicating an overall quality of a quality of a first service and a quality of a second service when the first service is switched to the second service, the first service being executed by a predetermined robot among the plurality of robots; calculating a non-switched service-quality level indicating an overall quality of the quality of the first service and the quality of the second service when the first service executed by the predetermined robot is not switched to the second service; and outputting switching information related to switching of the service, based on the switched service-quality level and the non-switched service-quality level.

By calculating the quality level when the service executed by a robot is switched and the quality level when the service is not switched in the above manner, it is possible to compare the switched service-quality level and the non-switched service-quality level. This prevents a reduction in overall quality of a plurality of services executed by a plurality of robots.

The service support method according to Example 2 is the service support method according to Example 1, and further includes: determining whether to switch the first service executed by the predetermined robot to the second service, based on the switched service-quality level and the non-switched service-quality level; and outputting a result of the determining as the switching information.

By determining whether to switch the first service executed by the robot to the second service, based on the quality level at the time of switching and the quality level at the time of non-switching in the above manner, it is possible to prevent a reduction in overall quality of the plurality of services including the first service and the second service.

The service support method according to Example 3 is the service support method according to Example 2, in which, in the determining, when the switched service-quality level is lower than or equal to the non-switched service-quality level, the first service executed by the predetermined robot may be determined not to be switched to the second service, and in the determining, when the switched service-quality level is higher than the non-switched service-quality level, the first service executed by the predetermined robot may be determined to be switched to the second service.

By determining whether to switch the first service executed by the robot to the second service in the above manner, it is possible to prevent a reduction in overall quality of the plurality of services including the first service and the second service.

The service support method according to Example 4 is the service support method according to any one of Examples 1 to 3, in which the calculating of the switched service-quality level and the calculating of the non-switched service-quality level may be performed when a trigger event occurs, the trigger event triggering a determination as to whether to switch the service; and the calculating of the switched service-quality level and the calculating of the non-switched service-quality level may not be performed when the trigger event does not occur.

With this, it is possible to determine whether to switch the service of the robot at an appropriate timing at which the trigger event occurs. This prevents a reduction in overall quality of a plurality of services executed by a plurality of robots.

The service support method according to Example 5 is the service support method according to any one of Examples 1 to 4, in which each of the switched service-quality level and the non-switched service-quality level may be derived based on an addition value and a deduction value, the addition value may be a sum of: a value obtained by multiplying a total number of robots that execute the first service by a first coefficient; and a value obtained by multiplying a total number of robots that execute the second service by a second coefficient, and the deduction value may be a sum of: a value that is deducted when the total number of robots that execute the first service is less than a first threshold value; and a value that is deducted when the total number of robots that execute the second service may be less than a second threshold value.

With this, it is possible to appropriately calculate the quality levels. Accordingly, it is possible to accurately determine whether to switch the service of the robot, preventing a reduction in overall quality of the plurality of services.

The service support method according to Example 6 is the service support method according to Example 5, in which an absolute value of the value that is deducted when the total number of robots that execute the first service is less than the first threshold value may be greater than the first coefficient, and an absolute value of the value that is deducted when the total number of robots that execute the second service is less than the second threshold value may be greater than the second coefficient.

With this, it is possible to appropriately calculate the quality levels. Accordingly, it is possible to appropriately determine whether to switch the service of the robot, preventing a reduction in overall quality of the plurality of services.

The service support method according to Example 7 is the service support method according to any one of Examples 1 to 6, and may further include: displaying the switching information on a monitor.

With this, for example, it is possible to present switching information indicating whether to switch the service to an operator and the like. This improves clarity of service support.

The service support method according to Example 8 is the service support method according to any one of Examples 1 to 7, in which the calculating of the switched service-quality level and the calculating of the non-switched service-quality level may be performed in a predetermined area in which the predetermined robot operates.

This prevents a reduction in overall quality of a plurality of services in a predetermined area in which a predetermined robot operates.

The service support method according to Example 9 is the service support method according to any one of Examples 1 to 8, in which the calculating of the switched service-quality level and the calculating of the non-switched service-quality level may be performed based on schedule information of the predetermined robot.

This prevents a reduction in overall quality of a plurality of services according to time.

The service support method according to Example 10 is the service support method according to any one of Examples 1 to 9, and may further include: causing an other robot that is different from the predetermined robot to execute the second service, when the first service executed by the predetermined robot is determined not to be switched to the second service, the other robot being included in the plurality of robots.

This prevents a reduction in overall quality of a plurality of services including the second service.

The service support method according to Example 11 is the service support method according to any one of Examples 1 to 9, and may further include: switching the first service executed by the predetermined robot to the second service after causing an other robot that is different from the predetermined robot to execute the first service when the first service executed by the predetermined robot is determined to be switched to the second service, the other robot being included in the plurality of robots.

This prevents a reduction in overall quality of a plurality of services including the first service.

The service support method according to Example 12 is the service support method according to any one of Examples 1 to 9, and may further include: switching the first service executed by the predetermined robot to the second service after causing an other robot that is different from the predetermined robot to temporarily execute the second service, when the first service executed by the predetermined robot is determined to be switched to the second service, the other robot being included in the plurality of robots.

This prevents a reduction in overall quality of a plurality of services including the second service.

A service support device according to Example 13 is a service support device that supports a service executed by a plurality of robots. The service support device includes: a quality level calculator that calculates: a switched service-quality level indicating an overall quality of a quality of a first service and a quality of a second service when the first service is switched to the second service, the first service being executed by a predetermined robot among the plurality of robots; and a non-switched service-quality level indicating an overall quality of the quality of the first service and the quality of the second service when the first service executed by the predetermined robot is not switched to the second service; and a switching information outputter that outputs switching information related to switching of the service, based on the switched service-quality level and the non-switched service-quality level.

By calculating the quality level at the time of switching the service executed by a robot and the quality level at the time of non-switching the service in the above manner, it is possible to compare the switched service-quality level and the non-switched service-quality level. The device prevents a reduction in overall quality of a plurality of services executed by a plurality of robots.

A robot according to Example 14 is the predetermined robot that communicates with the service support device described above. The robot operates based on the switching information output from the service support device.

The robot prevents a reduction in overall quality of a plurality of services.

A recording medium according to Example 14 is a non-transitory computer-readable recording medium having recorded thereon a program for causing a computer to execute the service support method according to any one of Examples 1 to 12.

The recording device provides a service support method that prevents a reduction in overall quality of a plurality of services executed by a plurality of robots.

Hereinafter, an exemplary embodiment and the like is described with reference to the accompanying Drawings. Each exemplary embodiment and the like described below shows a general or specific example. The numerical values, shapes, materials, structural elements, the arrangement and connection of the structural elements, steps, the processing order of the steps etc. shown in the following exemplary embodiment and the like are mere examples, and therefore do not limit the present disclosure. Among the structural elements in the following exemplary embodiment and the like, those not recited in any one of the independent claims are described as optional structural elements.

The drawings are schematic views and are not necessarily strictly illustrated. In the drawings, substantially the same configurations are designated by the same reference marks, and duplicate description may be omitted or simplified. In addition, even in a case where the same object is illustrated in the drawings, a scale may be changed for the sake of convenience.

In addition, in the present specification, terms indicating a relationship between elements, such as coincidence, equal, and parallel, terms indicating a shape of an element, such as plate-shape and rectangular shape, numerical values, and numerical ranges are not expressions representing only strict meanings, but are expressions meaning to include a substantially equivalent range, for example, a difference of about several %.

### Embodiment

### [Configuration of Service Support System]

A configuration of a service support system that includes robots and a service support device will be described with reference to FIG. 2 to FIG. 4.

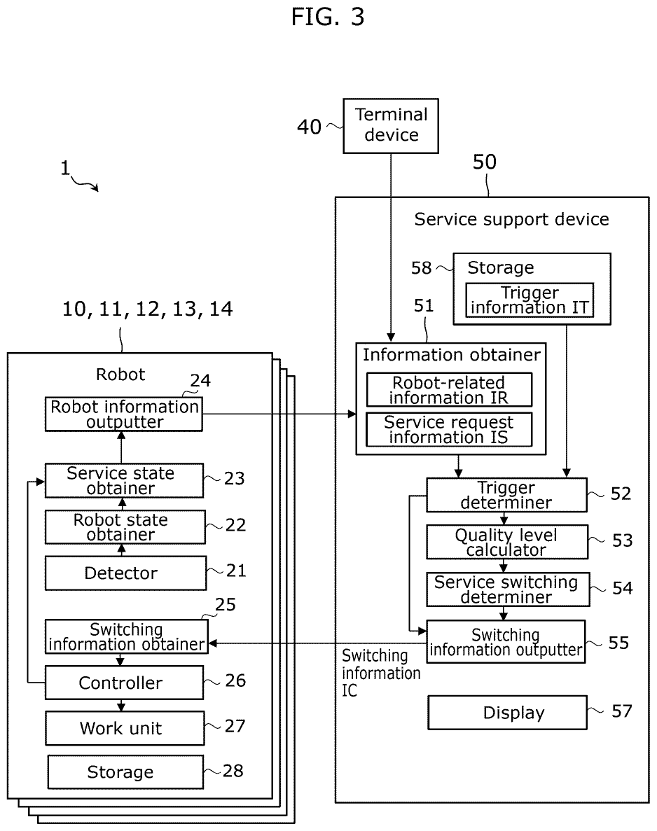

FIG. 2 illustrates an overall configuration of service support system 1. FIG. 3 is a block diagram illustrating a functional configuration of the robots and service support device 50 included in service support system 1.

As illustrated in FIG. 2 and FIG. 3, service support system 1 includes a plurality of robots 11, 12, 13 and 14 and service support device 50 that supports services. Note that terminal device 40 is also illustrated in these figures.

Service support device 50 is a device that supports services executed by the plurality of robots 11 to 14. Service support device 50 also functions as a management device that manages the operations of robots 11 to 14. Service support device 50 is provided in, for example, a building, such as an office building, a commercial facility, and a condominium. Service support device 50 may be provided in a place different from the place where robots 11 to 14 are located.

Terminal device 40 is communicatively connected to service support device 50 via communication network N. Information related to the services requested by the user is input to terminal device 40. Terminal device 40 transmits input service request information IS to service support device 50. In response to service request information IS, service support device 50 provides service support using robots 11 to 14.

Robots 11 to 14 and service support device 50 can communicate with each other via communication network N. In the following description, all or part of robots 11, 12, 13 and 14 may be referred to as robot 10. The number of robots 10 may be at least two, and may be 10 or 100.

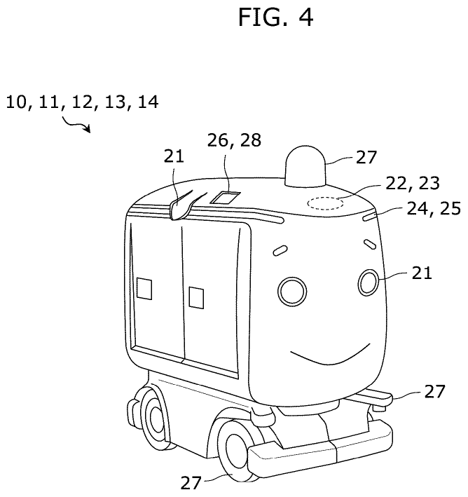

FIG. 4 is a schematic diagram of robot 10 that executes a service.

Robot 10 illustrated in FIG. 4 is an autonomous robot. Robot 10 executes various services based on schedule information transmitted from service support device 50. Robot 10 is a multi-service robot that executes various services, such as delivery, inspection and security, and cleaning, inside and outside a building. A detailed configuration of robot 10 and service support device 50 will be described below.

### [Configuration of Robot]

A configuration of robot 10 according to the embodiment will be described with reference to FIG. 3.

As illustrated in FIG. 3, robot 10 includes switching information obtainer 25, controller 26, work unit 27, and storage 28. Robot 10 also includes detector 21, robot state obtainer 22, service state obtainer 23, and robot information outputter 24.

Storage 28 is, for example, a volatile memory or a nonvolatile memory. Storage 28 stores a computer program for operating robot 10, the communication address of service support device 50, and trigger information IT to be described below. Storage 28 may store schedule information for robot 10 and map information about the inside and outside of the building.

Switching information obtainer 25 functions as a wireless communicator, and communicates with service support device 50 via communication network N. Switching information obtainer 25 obtains switching information IC output from service support device 50. Switching information IC includes information about whether to switch the service currently being executed by robot 10 to another service. Switching information IC obtained by switching information obtainer 25 is output to controller 26.

Controller 26 is, for example, a processor, and controls each structural element included in robot 10. In other words, controller 26 controls switching information obtainer 25, work unit 27, storage 28, detector 21, robot state obtainer 22, service state obtainer 23, and robot information outputter 24. Controller 26 outputs a work command to work unit 27 based on switching information IC output from switching information obtainer 25.

Work unit 27 operates based on the work command output from controller 26. Work unit 27 performs the work necessary to execute various services, based on the work command. Work unit 27 may be, for example, a vehicle mechanism for moving robot 10, a light that emits light, a loudspeaker that outputs sound, a monitor that outputs an image, a movable arm, or a cleaning mechanism.

Controller 26 also outputs information about the service currently being executed by robot 10 to service state obtainer 23. Controller 26 also controls the operation of detector 21 according to the service that is currently being executed by robot 10.

Detector 21 is a device that detects the current state of robot 10 and the surrounding conditions of robot 10. Detector 21 includes, for example, an acceleration sensor, a gyro sensor, and a global positioning system (GPS) device to detect the current state of robot 10. Detector 21 includes a camera, laser measuring instrument, microphone, and the like to detect the surrounding conditions of robot 10. The detection information detected by detector 21 is output to robot state obtainer 22.

Robot state obtainer 22 obtains information, such as the current state of robot 10 and the surrounding conditions of robot 10 detected by detector 21. The information obtained by robot state obtainer 22 is output to service state obtainer 23.

Service state obtainer 23 obtains information about the service that is currently being executed by robot 10. The information about the service includes the type of service that is currently being executed by robot 10 and information about the progress of the service. Service state obtainer 23 obtains information about the type of service from controller 26 and information about the progress of the service from robot state obtainer 22 connected to detector 21. The information obtained by service state obtainer 23 is output to robot information outputter 24.

Robot information outputter 24 obtains a plurality of items of information output from service state obtainer 23. The plurality of items of information output from service state obtainer 23 include robot information, such as the current state of the robot, the surrounding conditions of robot 10, and the service that is currently being executed by robot 10. Robot information outputter 24 functions as a wireless communicator, and is capable of communicating with service support device 50 via communication network N. Robot information outputter 24 transmits the obtained robot information to service support device 50.

### [Configuration of Service Support Device]

A configuration of service support device 50 according to the embodiment will be described with reference to FIG. 3.

As illustrated in FIG. 3, service support device 50 includes information obtainer 51, trigger determiner 52, quality level calculator 53, service switching determiner 54, switching information outputter 55, and storage 58.

By analyzing the robot information output from robot 10, information obtainer 51 obtains specific information, such as the current state of robot 10, the surrounding conditions of robot 10, and the service that is being executed by robot 10. In the following description, both the robot information output from robot 10 and the information obtained by analyzing the robot information will be referred to as robot-related information IR.

The information such as the current state of robot 10 and the surrounding conditions of robot 10 is used, for example, to identify anomalies that have occurred around robot 10. The current state of robot 10 is, for example, information, such as the speed, acceleration, and current position of robot 10. The surrounding conditions of robot 10 is, for example, information, such as objects around robot 10, the number of the objects, and the types of the objects. Examples of the objects around robot 10 include a person, such as a suspicious person, passerby, and sick person, and objects such as hazards, obstacles, garbage, and other robots. Examples of the objects may include building components such as walls, doors, columns, hallways, walls, and ceilings.

The service that is currently being executed by robot 10 includes information related to the type of service and the progress of the service. The information related to the type of service may be, for example, the tasks (duties) assigned to robot 10 in various services, such as delivery, inspection and security, and cleaning. The information related to the progress of the service is, for example, the service completion rate or the time required to complete the service. The information related to the progress of the service may be obtained by detecting checkpoints in each service. When the service is a delivery, the information related to the progress of the service may be the positional information of robot 10 while robot 10 is travelling or stopped.

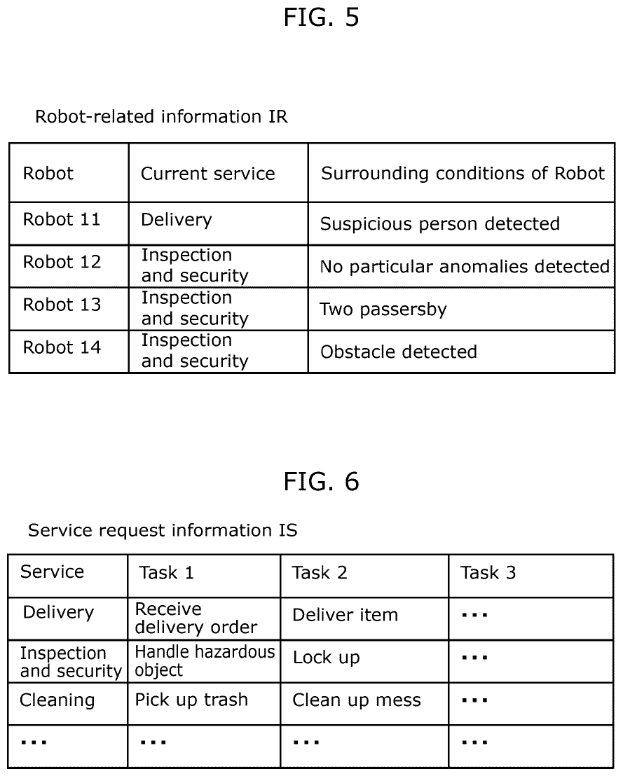

FIG. 5 illustrates an example of robot-related information IR obtained by service support device 50.

FIG. 5 illustrates examples of the services that are currently being executed by robots 11 to 14 and information related to the surrounding conditions of robots 11 to 14. Specifically, FIG. 5 illustrates that the service that is being executed by robot 11 is delivery, and the service that is being executed by each of robots 12, 13, and 14 is inspection and security. FIG. 5 also illustrates that there is a suspicious person around robot 11, there is no particular anomalies around robot 12, there are two passersby around robot 13, and there is an obstacle around robot 14.

Information obtainer 51 also obtains service request information IS output from terminal device 40.

FIG. 6 illustrates examples of service request information IS obtained by service support device 50.

Service request information IS includes the specific details of the service requested by the user. FIG. 6 illustrates the details of the tasks requested by users in various services such as delivery, inspection and security, and cleaning.

Information obtainer 51 outputs, to trigger determiner 52, robot-related information IR and service request information IS obtained.

Trigger determiner 52 is a processor that determines whether a trigger event that triggers determination as to whether to switch the service has occurred. Trigger determiner 52 makes the above determination by comparing robot-related information IR and service request information IS with trigger information IT stored in storage 58.

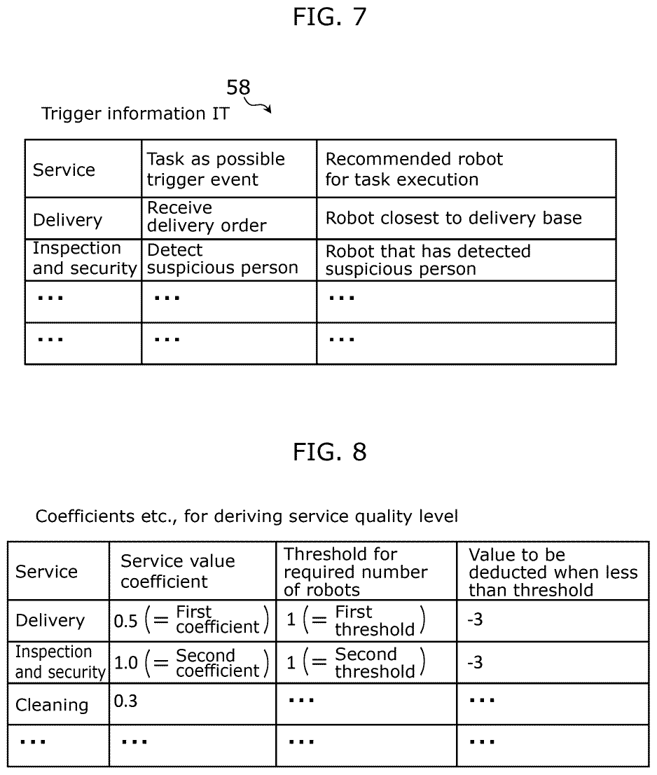

FIG. 7 illustrates trigger information IT stored in service support device 50.

Trigger information IT is information for determining whether a trigger event has occurred. Trigger information IT includes information related to the task (mission) that can serve as a trigger event and the recommended robot to execute the task. For example, FIG. 7 illustrates that when the service is delivery, the task that can serve as a trigger event is receiving a delivery order, and the recommended robot to execute the task is the robot closest to the delivery base. FIG. 7 also illustrates that when the service is inspection and security, the task that can serve as a trigger event is detection of a suspicious person, and the recommended robot to execute the task is the robot that has detected the suspicious person.

Trigger determiner 52 determines whether the task in trigger information IT is included in robot-related information IR or service request information IS. Trigger determiner 52 also determines whether the service that is currently being executed by the recommended robot matches the service corresponding to the task.

When the task in trigger information IT is not included in robot-related information IR or service request information IS, it is not the time to switch the service. Hence, trigger determiner 52 determines that no trigger event has occurred. When the service that is currently being executed by the recommended robot matches the service corresponding to the task, trigger determiner 52 determines that no trigger event has occurred because there is no need to switch the service. In these cases, trigger determiner 52 does not switch the current service, but outputs, to switching information outputter 55, a control signal for continuing the service. Switching information outputter 55 outputs switching information IC that includes information indicating that the current service is not switched and the service is to be continued.

On the other hand, when the task in trigger information IT is included in robot-related information IR or service request information IS, and when the service that is currently being executed by the recommended robot does not match the service corresponding to the task, trigger determiner 52 determines that a trigger event that triggers determination as to whether to switch the service has occurred. When a trigger event occurs, trigger determiner 52 outputs, to quality level calculator 53, a trigger signal for calculating the quality level of the service. Trigger determiner 52 also outputs, to quality level calculator 53, robot-related information IR and service request information IS used for the determination.

Quality level calculator 53 calculates the overall quality level of the plurality of services for each of when the service is switched and when the service is not switched, based on robot-related information IR and service request information IS. For example, quality level calculator 53 calculates switched service-quality level R1 indicating the overall quality of the first service and the second service when the first service executed by robot 10 is switched to the second service. Quality level calculator 53 also calculates non-switched service-quality level R0 indicating the overall quality of the first service and the second service when the first service executed by robot 10 is not switched to the second service.

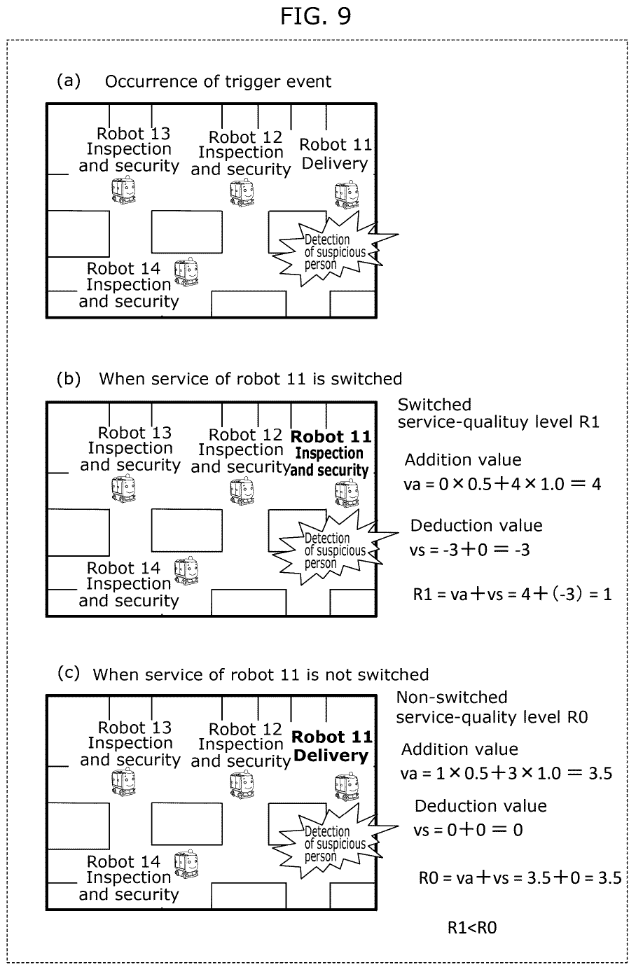

FIG. 8 illustrates the coefficients and the like for deriving quality levels R1 and R0 of services.

FIG. 8 illustrates the value coefficient for each service, a threshold value for the required number of robots 10, and the value to be deducted when the number of robots 10 is less than the threshold value. The value coefficient for each service, the threshold value for the number of robots 10, and the value to be deducted are determined by the importance and priority of the service. Each of the value coefficient, the threshold value for the number of robots 10, and the value to be deducted can be changed dynamically according to time or location.

In the following description, delivery will be described as a first service and inspection and security will be described as a second service. FIG. 8 illustrates an example in which a first coefficient that is a value coefficient for the first service is 0.5 and a second coefficient that is a value coefficient for the second service is 1.0. The value coefficient for each service in this example is set to be higher for the second service than for the first service.

FIG. 8 also illustrates that a first threshold value that is the threshold value for the number of robots 10 required in the first service is 1, and the value that is deducted when the required number of robots 10 is less than the first threshold value is −3. FIG. 8 also illustrates that a second threshold value that is the threshold value for the number of robots 10 required in the second service is 1, and the value that is deducted when the required number of robots 10 is less than the second threshold value is −3.

Each of the first threshold value and the second threshold value is set to reduce the risk caused by the switching of the service. For example, the absolute value of the value that is deducted when the number of robots 10 that execute the first service is less than the first threshold value is set to a value greater than the first coefficient, and the absolute value of the value that is deducted when the number of robots 10 that execute the second service is less than the second threshold value is set to a value greater than the second coefficient.

Quality level calculator 53 derives quality levels R1 and R0 based on addition value va and deduction value vs below. Addition value va is the sum of: the value obtained by multiplying the number of robots 10 that execute the first service by the first coefficient; and the value obtained by multiplying the number of robots 10 that execute the second service by the second coefficient. Deduction value vs is the sum of: the value that is deducted when the number of robots 10 that execute the first service is less than the first threshold value; and the value that is deducted when the number of robots 10 that execute the second service is less than the second threshold value.

Quality level calculator 53 derives each of quality levels R1 and R0 by summing addition value va and deduction value vs. Each of quality levels R1 and R0 calculated by quality level calculator 53 is output to service switching determiner 54.

Service switching determiner 54 determines whether to switch the first service executed by robot 10 to the second service, based on switched service-quality level R1 and non-switched service-quality level R0. Specifically, when switched service-quality level R1 is lower than non-switched service-quality level R0, service switching determiner 54 determines not to switch the first service executed by robot 10 to the second service. When switched service-quality level R1 is higher than non-switched service-quality level R0, service switching determiner 54 determines to switch the first service executed by robot 10 to the second service. The result of the determination by service switching determiner 54 is output to switching information outputter 55.

Switching information outputter 55 outputs the determination result to robot 11 as switching information IC. Robot 10 operates based on switching information IC. In this way, service support device 50 assigns the services to be executed by respective robots 10.

Switching information outputter 55 may output switching information IC to robot 11 after displaying switching information IC on display 57 of service support device 50. Switching information outputter 55 may also output switching information IC to robot 11 after displaying switching information IC on the monitor of a monitoring device that monitors the movement of robot 10.

### [Operation Example 1 of Robot and Service Support Device]

Operation Example 1 of robot 10 and service support device 50 will be described with reference to FIG. 9. In Operation Example 1, the case in which robot 11 detects a suspicious person around robot 11 will be described as an example.

FIG. 9 illustrates Operation Example 1 of robots 11 to 14 and service support device 50.

(a) in FIG. 9 illustrates an example in which the service that is being executed by robot 11 is delivery and the service that is being executed by robots 12 to 14 is inspection and security.

Information obtainer 51 obtains, based on the robot information transmitted from robot 11, robot-related information IR indicating that robot 11 has detected a suspicious person.

Trigger determiner 52 determines whether the information indicating the detection of a suspicious person corresponds to a trigger event that triggers determination as to whether to switch the service. In this case, trigger determiner 52 checks robot-related information IR against trigger information IT stored in storage 58, and determines that the information indicating the detection of a suspicious person is included in the task in trigger information IT. Trigger determiner 52 determines that the service that is currently being executed by the recommended robot does not match the service corresponding to the task, because the suspicious person was detected by robot 11 that is executing the delivery service. Trigger determiner 52 then determines that a trigger event that triggers determination as to whether to switch the service of robot 11 has occurred, and outputs a trigger signal to quality level calculator 53.

Based on the trigger signal, quality level calculator 53 calculates switched service-quality level R1 when the service is switched and non-switched service-quality level R0 when the service is not switched. In FIG. 9, (b) illustrates switched service-quality level R1, and (c) illustrates non-switched service-quality level R0.

As illustrated in (b) of FIG. 9, when the service that is being executed by robot 11 is switched from delivery to inspection and security, the number of robots that execute the delivery service becomes zero and the number of robots that execute the inspection and security service becomes four that are robots 11 to 14. In this example, too, delivery is described as the first service and inspection and security is described as the second service.

Switched service-quality level R1 is calculated by summing addition value va and deduction value vs.

Addition value va is calculated as follows. In this example, the value obtained by multiplying the number of robots that execute the first service by the first coefficient is 0 robot×0.5=0, and the value obtained by multiplying the number of robots that execute the second service by the second coefficient is 4 robots×1.0=4. As a result, the total of these values, addition value va, is va=4.

Deduction value vs is calculated as follows. In this example, the number of robots that execute the first service (=0) is less than the first threshold value (=1), so the value of the deduction is −3, and the number of robots that execute the second service (=4) is greater than the second threshold value (=1), so the value of the deduction is 0. As a result, the total of these values, deduction value vs is vs=−3. This gives switched service-quality level R1 as R1=va+vs=4+(−3)=1.

As illustrated in (c) of FIG. 9, when the service that is being executed by robot 11 is not switched from delivery to inspection and security, the number of robots that execute the delivery service becomes one, and the number of robots that execute the inspection and security service becomes three that is robots 12 to 14.

Non-switched service-quality level R0 is calculated by summing addition value va and reduction value vs.

Addition value va is calculated as follows. In this example, the value obtained by multiplying the number of robots that execute the first service by the first coefficient is 1 robot×0.5=0.5, and the value obtained by multiplying the number of robots that execute the second service by the second coefficient is 3 robots×1.0=3. As a result, the total value of these, addition value va, is va=3.5.

Deduction value vs is calculated as follows. In this example, the number of robots that execute the first service (=1) is equal to the first threshold value (=1), so the value of the deduction is 0, and the number of robots that execute the second service (=3) is greater than the second threshold value (=1), so the value of the deduction is 0. As a result, the total of these values, deduction value vs, is vs=0. This gives non-switched service-quality level R0 as R0=va+vs=3.5+0=3.5.

Therefore, in Operation Example 1 illustrated in FIG. 9, the overall quality of the services would not be reduced when the service that is currently being executed by robot 11 is not switched. Quality level calculator 53 outputs the results of these calculations to service switching determiner 54.

Since switched service-quality level R1 is less than or equal to non-switched service-quality level R0, service switching determiner 54 determines not to switch the first service executed by robot 11 to the second service. The result of the determination by service switching determiner 54 is output to switching information outputter 55. Switching information outputter 55 outputs, to robot 11, switching information IC including the result of the determination, i.e., switching information IC including information indicating that the service will not be switched. Robot 11 continues executing the current service without switching the service.

When the service of robot 11 is not switched, service support device 50 may cause another robot different from robot 11, such as a robot that is executing the second service, to execute the newly generated task.

### [Operation Example 2 of Robot and Service Support Device]

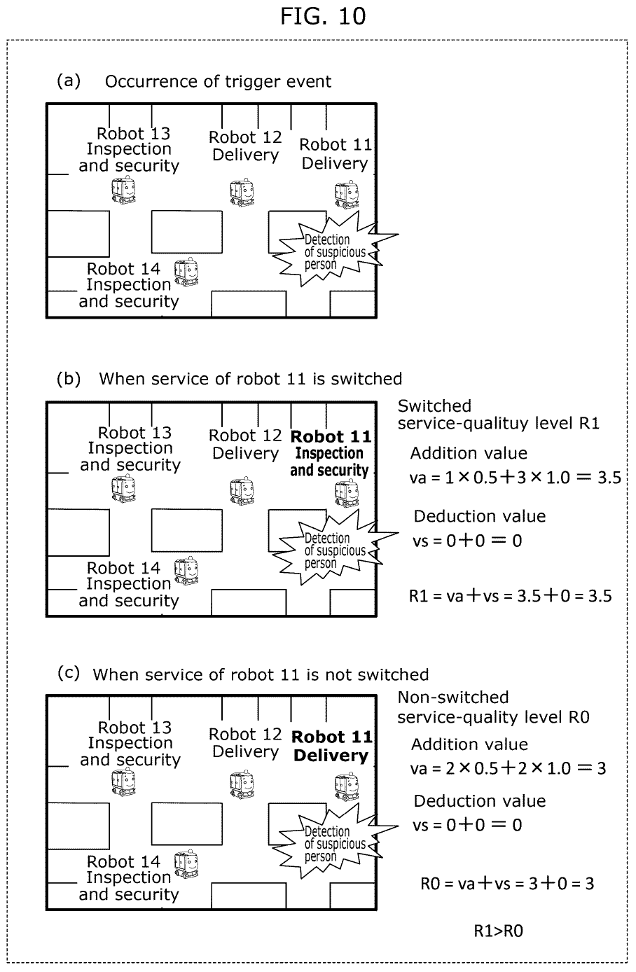

Operation Example 2 of robot 10 and service support device 50 will be described with reference to FIG. 10.

FIG. 10 illustrates Operation Example 2 of robots 11 to 14 and service support device 50.

(a) in FIG. 10 illustrates an example in which the service that is being executed by robots 11 and 12 is delivery and the service that is being executed by robots 13 and 14 is inspection and security.

In Operation Example 2, too, the case in which robot 11 detects a suspicious person around robot 11 will be described as an example. Operation Example 2 differs from Operation Example 1 in that two robots are executing the delivery service. The processes performed by information obtainer 51 and trigger determiner 52 in Operation Example 2 are the same as those in Operation Example 1, and thus, the explanation thereof will be omitted.

Based on the trigger signal from trigger determiner 52, quality level calculator 53 calculates switched service-quality level R1 when the service is switched and non-switched service-quality level R0 when the service is not switched. In FIG. 10, (b) illustrates switched service-quality level R1, and (c) illustrates non-switched service-quality level R0.

As illustrated in (b) of FIG. 10, when the service that is being executed by robot 11 is switched from delivery to inspection and security, the number of robots that execute the delivery service becomes one that is robot 12, and the number of robots that execute the inspection and security service becomes three that are robots 11, 13, and 14.

Switched service-quality level R1 is calculated by summing addition value va and deduction value vs.

Addition value va is calculated as follows. In this example, the value obtained by multiplying the number of robots that execute the first service by the first coefficient is 1 robot×0.5=0.5, and the value obtained by multiplying the number of robots that execute the second service by the second coefficient is 3 robots×1.0=3. As a result, the total of these values, addition value va, is va=3.5.

Deduction value vs is calculated as follows. In this example, the number of robots that execute the first service (=1) is equal to the first threshold value (=1), so the value of the deduction is 0, and the number of robots that execute the second service (=3) is greater than the second threshold value (=1), so the value of the deduction is 0. As a result, the total of these values, deduction value vs is vs=0. This gives switched service-quality level R1 as R1=va+vs=3.5+0=3.5.

As illustrated in (c) of FIG. 10, when the service that is being executed by robot 11 is not switched from delivery to inspection and security, two robots 11 and 12 execute the delivery service and two robots 13 and 14 execute the inspection and security service.

Non-switched service-quality level R0 is also calculated by summing addition value va and deduction value vs.

Addition value va is calculated as follows. In this example, the value obtained by multiplying the number of robots that execute the first service by the first coefficient is two robots×0.5=1, and the value obtained by multiplying the number of robots that execute the second service by the second coefficient is two robots×1.0=2. As a result, the total of these values, addition value va, is va=3.

Deduction value vs is calculated as follows. In this example, the number of robots that execute the first service (=2) is greater than the first threshold value (=1), so the value of the deduction is 0, and the number of robots that execute the second service (=2) is greater than the second threshold value (=1), so the value of the deduction is 0. As a result, the total of these values, deduction value vs, is vs=0. This gives non-switched service-quality level R0 as R0=va+vs=3+0=3.

Therefore, in Operation Example 2 illustrated in FIG. 10, the overall service quality will not be reduced when the service currently being executed by robot 11 is switched. Quality level calculator 53 outputs the results of the calculations to service switching determiner 54.

Since switched service-quality level R1 is greater than non-switched service-quality level R0, service switching determiner 54 determines to switch the first service executed by robot 11 to the second service. The result of the determination by service switching determiner 54 is output to switching information outputter 55. Switching information outputter 55 outputs, to robot 11, switching information IC including the result of the determination, i.e., switching information IC including information indicating that the service is to be switched. Robot 11 switches the first service to the second service and executes the second service.

### [Service Support Method]

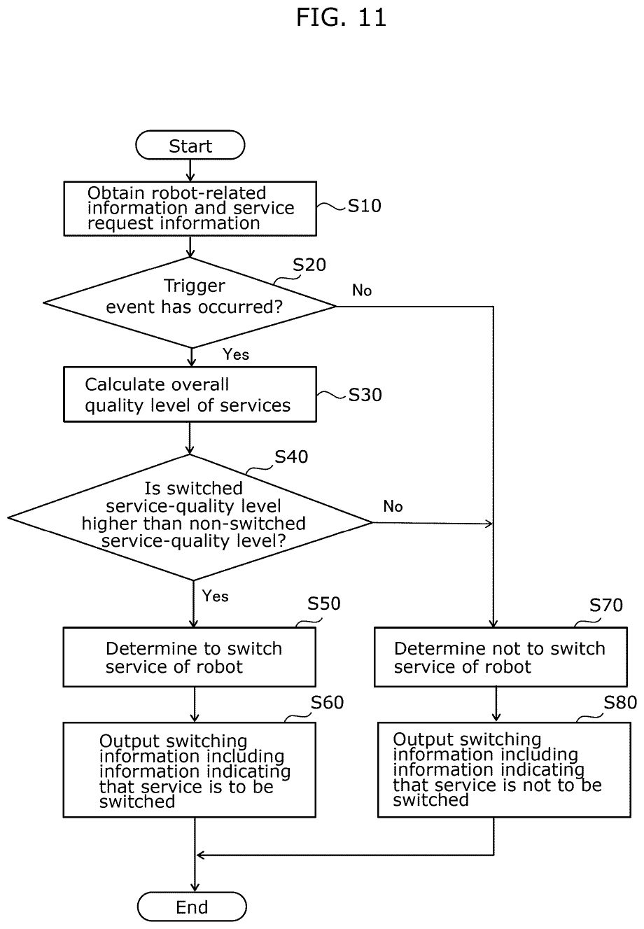

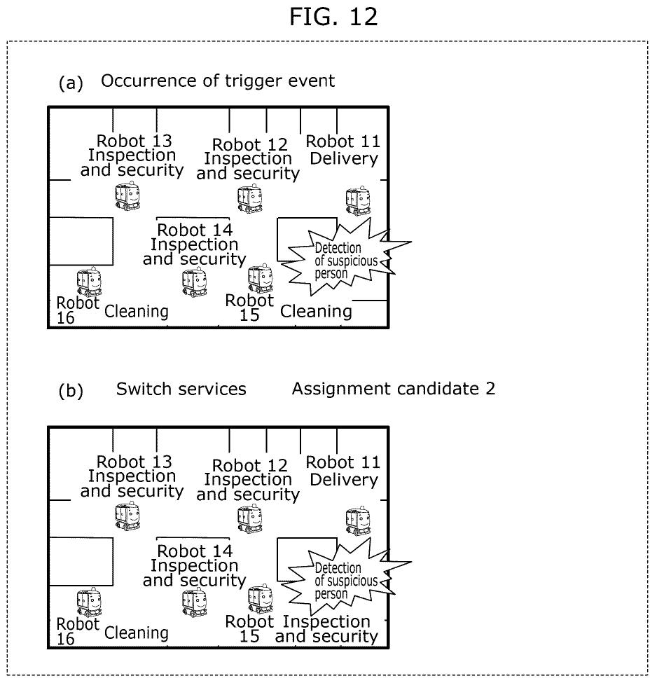

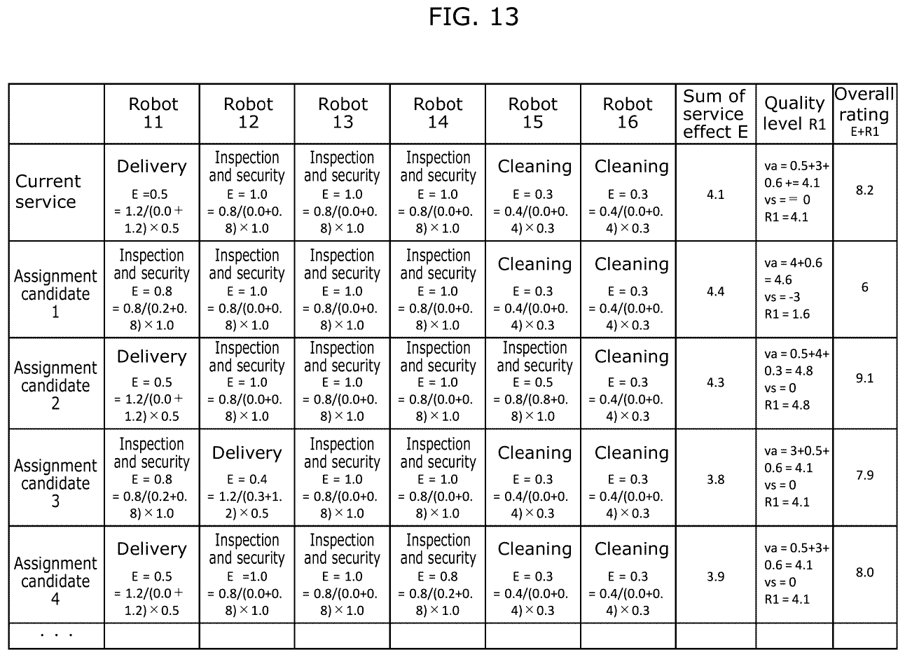

A service support method according to the embodiment will be described with reference to FIG. 11.

FIG. 11 is a flowchart of a service support method according to the embodiment.

As illustrated in FIG. 11, service support device 50 obtains robot-related information IR and service request information IS (step S10).

Based on robot-related information IR and service request information IS, service support device 50 determines whether a trigger event that triggers determination as to whether to switch the service of robot 10 has occurred (step S20). First, service support device 50 determines whether or not the task included in trigger information IT is included in robot-related information IR or service request information IS. Service support device 50 also determines whether the service currently being executed by the recommended robot matches the service corresponding to the task.

When the task in trigger information IT is included in robot-related information IR or service request information IS and the service currently being executed by the recommended robot does not match the service corresponding to the task, service support device 50 determines that a trigger event that triggers determination as to whether to switch the service has occurred.

When no trigger event has occurred (No in S20), service support device 50 determines not to switch the service currently being executed (step S70). On the other hand, when the trigger event has occurred (Yes in S20), service support device 50 proceeds to the next step.

In the next step, based on robot-related information IR and service request information IS, service support device 50 calculates the overall quality level of a plurality of services for each of when the service is switched and when the service is not switched (step S30).

For example, service support device 50 calculates switched service-quality level R1 indicating the overall quality of the first service and the second service when the first service executed by robot 10 is switched to the second service. Quality level calculator 53 also calculates non-switched service-quality level R0 indicating the overall quality of the first service and the second service when the first service executed by robot 10 is not switched to the second service.

Service support device 50 then determines whether switched service-quality level R1 is higher than non-switched service-quality level R0 (step S40).

When switched service-quality level R1 is lower than or equal to non-switched service-quality level R0 (No in S40), service support device 50 determines not to switch the first service executed by robot 10 to the second service (step S70). In other words, service support device 50 determines to continue the service currently being executed by robot 10. After step S70, service support device 50 outputs switching information IC including information indicating that the service is not to be switched (S80).

On the other hand, when switched service-quality level R1 is higher than non-switched service-quality level R0 (Yes in S40), service support device 50 determines to switch the first service executed by robot 10 to the second service (step S50).

Service support device 50 outputs switching information IC including information indicating that the service is to be switched (step S60). Steps S10 to S80 are repeatedly executed between service support device 50 and the plurality of robots 10. By executing steps S10 to S80, it is possible to prevent a reduction in overall quality of the plurality of services executed by the plurality of robots 10.

### Variation 1 of Embodiment

A service support method according to Variation 1 of the embodiment will be described with reference to FIG. 12 and FIG. 13.

FIG. 12 illustrates a service support method according to Variation 1 of the embodiment.

(a) in FIG. 12 illustrates an example in which the service that is being executed by robot 11 is delivery, the service that is being executed by robots 12, 13, and 14 is inspection and security, and the service that is being executed by robots 15 and 16 is cleaning.

In Variation 1, too, the case in which robot 11 detects a suspicious person around robot 11 will be described as an example. Variation 1 differs from Operation Example 1 above in that two additional robots are executing the cleaning service. The processes performed by information obtainer 51 and trigger determiner 52 according to Variation 1 are the same as those in Operation Example 1, and thus, the description thereof is omitted.

FIG. 13 illustrates candidates for assignment of services to be executed by robot 10.

As illustrated in FIG. 13, in Variation 1, in addition to the quality level, service effect E in (Expression 1) is also included in the evaluation items.

$$E = a \times t 1 / ( t 0 + t 1 ) \qquad ( Expression 1 )$$

In Variation 1, service parameter α is set to 0.5 and execution time t1 is set to 1.2 when the service is delivery, service parameter α is set to 1 and execution time t1 is set to 0.8 when the service is inspection and security, and service parameter α is set to 0.3 and execution time t1 is set to 0.4 when the service is cleaning. Travel time t0 when the service is switched from delivery to inspection and security is set to 0.2, travel time t0 when the service is switched from inspection and security to delivery is set to 0.3, and travel time t0 when the service is switched from cleaning to inspection and security is set to 0.5.

FIG. 13 shows the sum of service effects E of robots 11 to 16. Focusing on the sum of service effects E here, assignment candidate 1 has a higher service effect E than the other candidates, but the overall rating, which includes both service effect E and switched service-quality level R1, has a lower score than the other candidates.

In this example, service effect E of assignment candidate 2 is 4.3, which is lower than service effect E of assignment candidate 1. However, switched service-quality level R1 is 4.8 and the overall rating is 9.1 for assignment candidate 2, so that assignment candidate 2 has a higher score than the other candidates. Therefore, in Variation 1, assignment candidate 2 is selected and the service of robot 15 is switched from cleaning to inspection and security as illustrated in (b) of FIG. 12. This prevents a reduction in overall quality of the plurality of services executed by robot 10.

In this way, robot 10 and service support device 50 may perform an overall evaluation including both service effect E and the quality level to determine the assignment of services to be executed by robot 10.

### Variation 2 of Embodiment

In the service support method described above, for example, switching information IC may be output to robot 10 immediately after service switching determiner 54 determines to switch the service, but the present disclosure is not limited to such an example. In Variation 2, an example will be described in which, after switching information IC is displayed on the monitor, information about whether to switch the service is output to robot 10 based on the input information input by an operator.

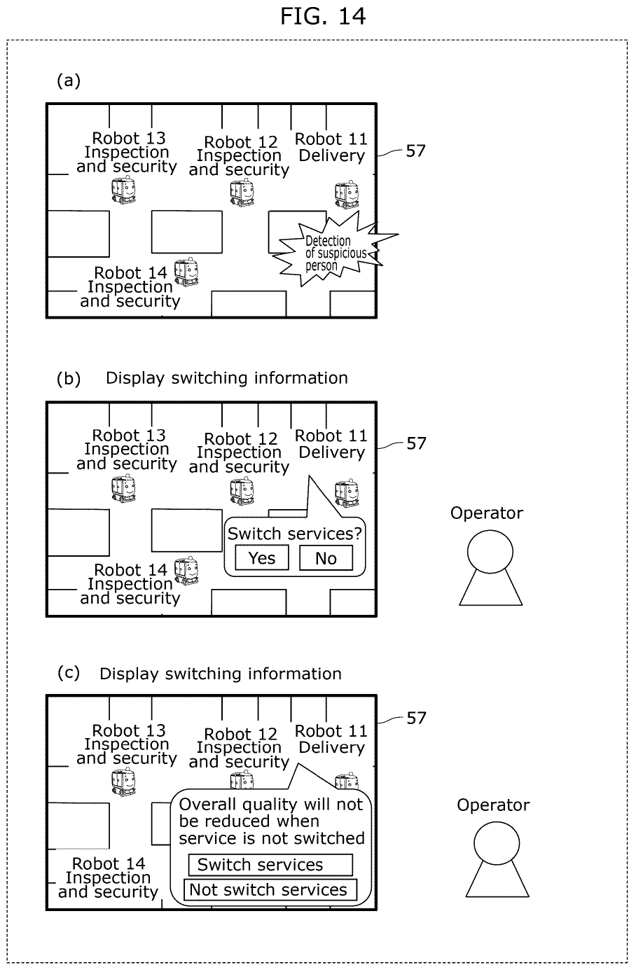

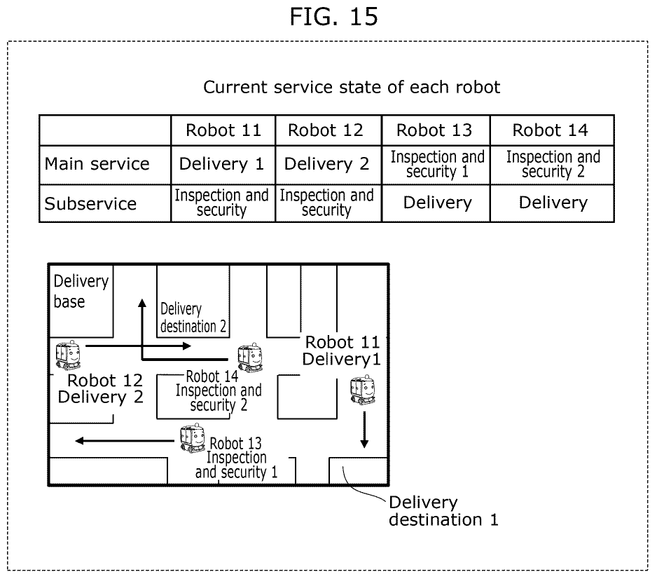

FIG. 14 is a diagram for explaining a service support method according to Variation 2 of the embodiment.

In FIG. 14, (a) illustrates a state in which robot 11 executing the delivery service has detected a suspicious person, and (b) and (c) illustrate examples in which switching information IC is displayed on display 57 of service support device 50. Specifically, (b) in FIG. 14 illustrates a screen confirming whether to switch the service of robot 11 from delivery to inspection and security. (c) of FIG. 14 illustrates a screen confirming whether to switch the service after presenting that the overall quality of the services will not be reduced when the service of robot 11 that is executing the delivery service is not switched.

Service support device 50 presents these screens to the operator. For example, service support device 50 may ask the operator to determine whether to switch the service when the difference between quality level R0 and quality level R1 is less than or equal to a predetermined range (e.g., when the difference is small). Since always making the operator to make the determinations would require more man-hours and increase the workload, the operator may be asked to determine whether to switch the service only when the difference between quality level R0 and quality level R1 is small.

Service support device 50 outputs, to robot 10, information related to whether to switch the service, based on the input information input by the operator who has checked the screens.

For example, when service support device 50 displays switching information on the monitor to let the operator determine whether to switch the service, service support device 50 may present, as switching information, the estimated time of completion of the service before the switching. The estimated time of completion is, for example, the scheduled delivery time in the case of delivery, or the time at which visiting all inspection points has been completed in the case of inspection and security. When the scheduled service completion time is close to the current time when the operator determines whether to switch the service, the service is continued without being switched and another service can be requested after the current service is completed. This allows the services to be executed efficiently.

In such a manner, service support device 50 may display a screen to confirm whether to switch the service of robot 10, or service support device 50 may display not only a screen to confirm whether to switch the services, but also information about recommended service support. Service support device 50 may also display these items of confirmation information on a terminal device different from service support device 50.

### Variation 3 of Embodiment

In the service support method described above, for example, quality level calculator 53 may calculate the quality levels of the entire services for the area in which a plurality of robots 10 are operating, and determine whether to switch services based on the calculated quality levels. However, the present disclosure is not limited to such an example. In Variation 3, an example will be described in which, when calculating switched service-quality level R1 and non-switched service-quality level R0, quality levels R1 and R0 are calculated in some predetermined areas where robot 10 operates.

For example, when there are robot 11 for delivery and robots 12 and 13 for inspection and security in a first area, and there are robots 14 and 15 for delivery and robot 16 for inspection and security in a second area, switching the service of robot 11 from delivery to inspection and security is not a major problem in the overall area, since there are other robots 14 and 15 that execute the delivery service. However, there will be no robots that execute the delivery service in the first area. Hence, focusing on the first area, the service quality will be reduced.

In this way, when determining whether to switch the service, whether to switch the service may be determined focusing on not only the entire area to which the services are provided but also the quality levels of the services in some predetermined areas. This prevents a reduction in service quality in a predetermined area.

### Variation 4 of Embodiment

In the above service support method, for example, the quality level may be calculated by setting a threshold value for the number of robots 10 required for each service to a predetermined value, but is not limited to such an example. The threshold value for the number of robots 10 required for each service may be changed dynamically based on the demand for each service and the environment.

For example, by predicting the possibility of harm given by a suspicious person, the threshold value for the number of robots 10 that execute the inspection and security service during the hours before the start of business may be set to 0, and the threshold value for the number of robots 10 that execute the inspection and security service during hours on holidays when there are many children may be set to two. This allows the services to be provided according to the demand and environment, and prevents a reduction in the service quality.

### Variation 5 of Embodiment

In the above service support method, for example, the service quality level may be calculated at a predetermined time when the plurality of robots 10 are in operation, and whether to switch the service may be determined based on the quality level at that time. However, the present disclosure is not limited to such an example. In Variation 5, an example in which the service quality level is calculated based on the schedule information of robot 10 will be described. The schedule information is information generated by predicting where and when services are likely to occur, based on the past performance and the like.

In this example, whether to switch the service is determined by not only calculating the quality level of the service at the time of switching the service, but also by calculating the quality level of the service for a predetermined period of time after the switching or after a predetermined period of time elapses from the switching. For example, when a trigger event that triggers determination as to whether to switch the service of a robot occurs, it may be better to temporarily switch the service. However, it may be better not to switch the service when another trigger event is expected to occur in 10 minutes. Whether to switch the service may be determined based on the quality level of the service in consideration of the time elapse of 10 minutes.

In this way, when determining whether to switch the service, the quality level may be calculated based on the schedule information of robot 10 to determine whether to switch the service. This prevents a reduction in service quality even after an elapse of a predetermined period of time.

### Variation 6 of Embodiment

In the service support method described above, when the first service executed by robot 10 is determined not to be switched to the second service, the second service may be executed by another robot that is different from robot 10.

For example, when a trigger event occurs which triggers determination as to whether to switch the service of robot 11 from delivery to inspection and security, but it is determined based on the calculation results of the service quality levels that it is better not to switch the service of robot 11, another robot 12 that is present around robot 11 may be caused to execute the service.

### Variation 7 of Embodiment

In the service support method described above, when the first service executed by robot 10 is determined to be switched to the second service, the service executed by robot 10 may be switched to the second service after causing another robot that is different from robot 10 to execute the first service.

For example, when a trigger event occurs which triggers determination as to whether to switch the service of the robot and the service is determined to be switched, the first service that is being executed by robot 11 may be switched after waiting for a while instead of switching the service immediately. Specifically, service support device 50 may wait until another robot 12 arrives at the position of robot 11, cause the other robot 12 to execute the first service that is being executed by robot 11 after the arrival, and then switch the service executed by robot 11 to the second service.

In this way, by causing another robot 12 to execute the first service that is being executed by robot 11 and then switching the service of robot 11, it is possible to prevent the first service executed by robot 11 from being interrupted. This prevents a reduction in service quality.

### Variation 8 of Embodiment

In the service support method described above, when the first service executed by robot 10 is determined to be switched to the second service, the service executed by robot 10 may be switched to the second service after causing another robot that is different from robot 10 to execute the second service temporarily.

For example, when a trigger event occurs which triggers determination as to whether to switch the service of the robot and the service is determined to be switched, the second service that is being executed by another robot 12 may be switched after waiting for a while instead of being switched immediately. Specifically, service support device 50 may wait until robot 11 arrives at the position of the other robot 12, cause robot 11 to execute the second service that is being executed by the other robot 12 after the arrival, and then switch the service of robot 12 to another service.

In this way, by causing robot 11 to execute the second service that is being executed by another robot 12 and then switching the service of robot 11, it is possible to prevent the second service that robot 11 is about to execute from being interrupted. This prevents a reduction in service quality.

### Variation 9 of Embodiment

In Variation 9 of the embodiment, another example will be described in which each robot executes a plurality of services simultaneously.

For example, as in Table 1, it is assumed that there are four robots that execute the delivery service and the inspection and security service, with a main service and a subservice assigned to each of robots 11 to 14. Each of robots 11 to 14 is capable of switching between the main service and the subservice and executing the service.

TABLE 1

| | Robot 11 | Robot 12 | Robot 13 | Robot 14 |
|---|---|---|---|---|
| Main service | Delivery | Delivery | Inspection | Inspection |
| | | | and security | and security |
| Subservice | Inspection | Inspection | Delivery | Delivery |
| | and | and | | |
| | security | security | | |

The robot to which the delivery service has been assigned executes the delivery service while traveling based on the delivery route. The robot to which the inspection and security service has been assigned executes the inspection and security service while traveling based on the patrol route.

However, without a balanced distribution between robots whose service is delivery and robots whose service is inspection and security, the overall service may be biased toward one service or the other, reducing the overall effectiveness, efficiency, and quality of the services. For example, a heavy emphasis on the delivery service will result in many areas of missed inspections, reducing the efficiency of inspection and security. On the other hand, a heavy emphasis on the inspection and security service will result in fewer cases where delivery can be made via the shortest route, thus reducing the efficiency of delivery. Therefore, the distribution of the number of robots that execute the services is switched in consideration of the overall quality of the services. The proportion of the number of robots and the like can be changed dynamically depending on the time of day and other factors.

Table 2 shows examples of a switching trigger that triggers switching to another service.

TABLE 2

| Service | Switching trigger |
|---|---|
| Delivery | Receiving delivery order |
| Inspection and | Detecting suspicious person, receiving report of |
| security | suspicious person, schedule (regular inspection |
| | time) |
| Cleaning | Detecting dirty spot within area, receiving |
| | cleaning order, schedule (regular cleaning |
| | time) |
| Advertising | Robot has no other duties, Detecting densely |
| | populated place within area |

For example, the switching trigger that triggers the switching to the delivery service is receiving a delivery order. When service support device 50 obtains delivery request information (information such as delivery item, delivery location, and delivery time), service support device 50 determines that a delivery order has been received.

For example, the switching trigger that triggers the switching to the inspection and security service is detecting a suspicious person, receiving a report of a suspicious person, or a schedule (regular inspection time). When service support device 50 detects, among the traffic participants around the robot, a person who has stayed in the same place for a certain period of time or who is wandering around the same place, service support device 50 determines that the person is suspicious. The surrounding information of the robot can be obtained by detector 21 such as a sensor provided to the robot. When service support device 50 obtains information on a report of a suspicious person (reported location of the suspicious person, the details of the report, etc.), service support device 50 determines that a report of a suspicious person has been received. Service support device 50 also determines the switching time based on a predetermined schedule.

Examples of the switching trigger that triggers the switching to the cleaning service is detecting a dirty spot in the area, receiving a cleaning order, or a schedule (regular cleaning time). Service support device 50 compares image information currently and previously taken for the same place, and determines that the place where the image was taken is dirty when there is a difference in the image information. In this case, service support device 50 may detect whether the dirty spot is cleanable by a robot. For example, the semantic segmentation technique may be used to detect whether the dirty spot is cleanable by a robot. Moreover, service support device 50 determines that a cleaning order has been received when service support device 50 obtains cleaning information (information about the cleaning location, the details of the dirty spot, etc.). Service support device 50 also determines the switching time based on a predetermined schedule.

For example, the switching trigger that triggers the switching to the advertising service is that the robot has no other duties or the like, or that the robot detects a densely populated place within the area. In service support device 50, a service state obtainer obtains service state information indicating whether there is nothing to be done as the main task. Based on this service state information and the service management information of the robot, service support device 50 determines whether to switch the subtask to advertising. Service support device 50 detects the place where the population density is high in the area by detecting whether the number of traffic participants around the robot is greater than a predetermined number and whether the surrounding traffic participants are within a predetermined range (area). Information about the surrounding conditions of the robot can be obtained by detector 21, such as a sensor provided to the robot.

Other examples of the switching of the service will be described.

For example, when the number of delivery orders temporarily increases and the delivery tasks suddenly increases, service support device 50 may change the service of a robot that is executing a service other than the delivery to delivery. When a robot detects a dirty spot during the inspection and security service in a given area and the dirty spot can be cleaned by the robot, the robot may propose the switching of the service to service support device 50, and the service of the robot may be changed to cleaning. When a robot detects a crowded spot in the area through an inspection during the inspection and security service, the robot may propose the switching of the service to service support device 50, and the service of the robot may be changed to advertising. When a report indicating that a person who appears to be suspicious has been detected is received, but the position of the suspicious person is unknown, service support device 50 may turn the entire area into an enhanced security mode.

Next, specific examples regarding the switching of the service will be described.

FIG. 15 illustrates an example of the services that are currently being executed by robots 11 to 14.

In FIG. 15, four robots are arranged that execute the delivery service and the inspection and security service. In this example, the service of robot 11 is delivery 1, the service of robot 12 is delivery 2, the service of robot 13 is inspection and security 1, and the service of robot 14 is inspection and security 2. The proportion of the delivery service in the entire services is 50%, and the proportion of the inspection and security service is also 50%.

In this state, when a person who appears to be suspicious is detected and a report related to the suspicious person is received, but the position of the suspicious person is unknown, service support device 50 turns the entire area into an enhanced security mode. Service support device 50 sets the proportion of the robots that execute the inspection and security service to the entire services to be at least 75% in the enhanced security mode.

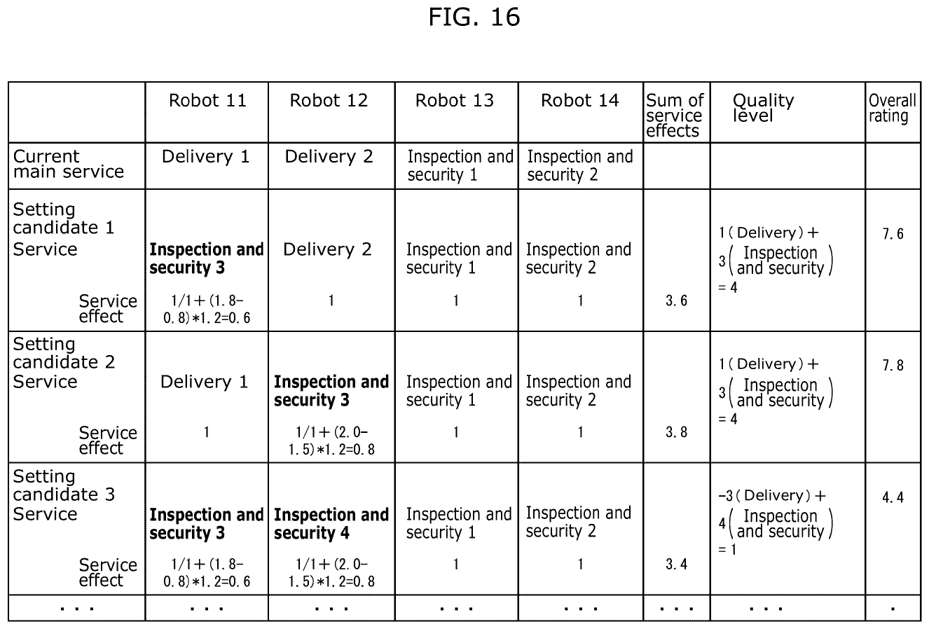

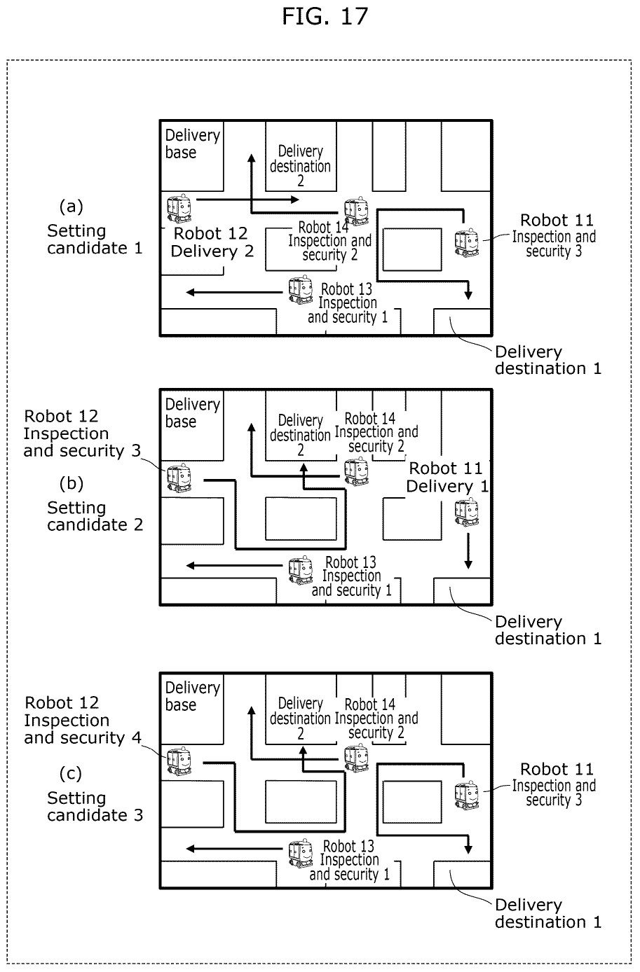

FIG. 16 illustrates setting candidates 1, 2 and 3 for service assignments for robots 11 to 14. FIG. 17 illustrates Operation Example 3 of robots 11 to 14 and service support device 50. In FIG. 17, (a), (b), and (c) illustrate the operations of setting candidates 1, 2, and 3, respectively.

In the example illustrated in FIG. 16, the sum of service effects for setting candidate 1 is 3.6, the sum of service effects for setting candidate 2 is 3.8, and the sum of service effects for setting candidate 3 is 3.4. In the example illustrated in FIG. 16, the quality level of setting candidate 1 is 4, the quality level of setting candidate 2 is 4, and the quality level of setting candidate 3 is 1. FIG. 16 also shows each overall rating that is the sum of the service effect and quality level. In FIG. 16, the overall rating for setting candidate 1 is 7.6, the overall rating for setting candidate 2 is 7.8, and the overall rating for setting candidate 3 is 4.4. In this example, setting candidate 2 has the highest overall rating.

The process details a, b and c for changing the proportion of robots that execute the inspection and security service from 50% to 75% will be described below. The details of each process a to c are as indicated below.
Process details a: select robot whose service is to be changed to inspection and security
Process details b: when the service is changed, determine when to change the service
Process details c: determine how to change current service

First, “Process details a: select robot whose service is to be changed to inspection and security” will be described.

Service support device 50 reassigns the service so that the condition to be achieved is met and the sum of the quality level and service effect is the highest. The condition to be achieved in this example is that the proportion of robots that execute the inspection and security service to the entire services is set to be at least 75%.

The value of the service effect when the service is switched is derived by (Expression 2) below.

$$( Expression 2 )$$

$$Service effect = 1 / 1 + \vert ( estimated end time when main service is switched to subservice ) - ( estimated end time of current main service ) \vert \times ( priority of main service after switching )$$

The priority of the main service after the switching is, for example, 1.2 for the inspection and security service and 1 for the delivery service. The service effect is 1 when the service is not switched.

The quality level is determined by the number of robots that execute the service. For example, when the number of robots that execute a service is greater than or equal to a predetermined threshold value, the quality level is 1×the number of robots. When the number of robots that execute the service is less than the predetermined threshold value, the quality level is −3. The predetermined threshold value in this example is one.

In selecting a robot whose service is to be switched, it is desirable to select a robot that has a small difference between the estimated service end time when the service is continued without switching and the estimated service end time when the service is switched. It is also desirable to select a robot, in consideration of the magnitude of effect of switching the service (e.g., there will be no robot that executes a certain service). It is also desirable to set the priority for each service in advance, and to select a robot by considering the priority of the main service after the switching. Moreover, the robot with the largest difference when the priority of the current main service is subtracted from the priority of the main service after the switching may be selected.

When the service that is being executed has a higher priority, the robot that executes the service that corresponds to the priority may be set as the robot whose main service is not changed. The service that corresponds to the priority is, for example, that a delivery service robot gives priority to those who have enrolled in a premium course of the delivery service when making deliveries.

Next, “Process details b: when changing the service, determine when to change the service” will be described.

For example, the service of each robot is switched when an instruction for changing the service is received from service support device 50, such as changing from the delivery service to the inspection and security service. When the difference between the estimated service end time when the service is continued and the estimated service end time when the service is switched is less than or equal to a predetermined third threshold value, the service of the robot is immediately switched. When the difference is not less than or equal to the third threshold value, it is determined whether the difference between the estimated service end time when the service is continued and the current time is less than or equal to a predetermined fourth threshold value.

When the above difference is less than or equal to the fourth threshold value, the current service is continued, and after the end of the current service, the service is switched to another service. When the difference is not equal to or less than the fourth threshold value, the service of the robot is switched immediately. In this example, the original service is set to a subservice, and the service end time is allowed to be delayed.

When the difference is not less than or equal to the fourth threshold value, it may be that another robot around the robot takes over the service and that it is determined whether the difference between the estimated service end time and the current time is less than or equal to the fourth threshold value. When the difference is not less than or equal to the fourth threshold value, the other robot around the robot takes over the service and the current service is switched.

For example, there are robot X whose main service is cleaning and whose subservice is inspection and security, and robot Y whose main service is inspection and security and whose subservice is cleaning. It is assumed that the inspection and security in the area is determined to be increased, so the service of robot X is changed from the cleaning to the inspection and security. Such a case will be described. For example, when robot X executes the cleaning service along the patrol route of the inspection and security service and the cleaning time takes significantly longer than the schedule, and when there are cleaning spots to be cleaned as the main task of robot X along the patrol route of the inspection and security service of robot Y, service support device 50 causes robot Y to take over the cleaning that is the main service of robot X, and to clean the cleaning spots while robot Y executes the inspection and security service.

Next, “Process details c: determine how to change current service” will be described.

For example, when the service is “changed from delivery to inspection and security”, the current delivery route is changed to a patrol route that gives priority to inspection and security. When the service is “changed from delivery to advertising”, the current delivery route is changed to a traveling route that gives priority to crowded areas. Information related to the crowded areas is obtained from historical information or sensor information. When the service is “changed from delivery to cleaning”, the current delivery route is changed to a cleaning route that gives priority to cleaning spots. Then, after cleaning is executed at the cleaning spots, the service is reverted to delivery.

For example, when the service is “changed from inspection and security to delivery”, the current patrol route is changed to a delivery route that gives priority to delivery. When the service is “changed from inspection and security to advertising”, the current patrol route is changed to a traveling route that gives priority to crowded areas. Information related to the crowded areas is obtained from historical information or sensor information. When the service is “changed from inspection and security to cleaning”, the current patrol route is changed to a cleaning route that gives priority to cleaning spots. Then, after cleaning is executed at the cleaning points, the service is reverted to inspection and security.

For example, when the service is “changed from advertising to delivery”, the current traveling route is changed to a delivery route that gives priority to delivery. For example, when the service is “changed from advertising to inspection and security”, the current traveling route is changed to a patrol route that gives priority to inspection and security. When the service is “changed from advertising to cleaning”, the current traveling route is changed to a cleaning route that gives priority to cleaning spots. Then, after cleaning is executed at the cleaning spots, the service is reverted to advertising.

For example, when the service is “changed from cleaning to delivery”, the current cleaning route is changed to a delivery route that gives priority to delivery. In this case, while giving priority to delivery, cleaning is executed when the robot passes through the cleaning spots. When the service is “changed from cleaning to inspection and security”, the current cleaning route is changed to a patrol route that gives priority to inspection and security. In this case, while giving priority to inspection and security, cleaning is executed when the robot passes through the cleaning spots. When the service is “changed from cleaning to advertising”, the current cleaning route is changed to a traveling route that gives priority to crowded areas. In this case, while giving priority to advertising, cleaning is executed when passing through the cleaning spots.

In this way, in Variation 9 of the embodiment, a main service and a subservice are assigned to each of robots 11 to 14, and service support device 50 switches between the main service and subservice for each of robots 11 to 14 and causes each of robots 11 to 14 to execute the service. In addition, in Variation 9, the service effect is derived based on the difference between the scheduled end time when the main service is switched to the subservice and the scheduled end time of the current main service, and an evaluation is performed when the service is switched, based on the service effect and quality level.

Next, the evaluation performed when the service is switched will be further described.

For example, for delivery, the magnitude of effect may be determined based on whether delivery can be made quickly, whether delivery can be made at the right time, whether delivery can be made to the right person, whether the right item can be delivered, whether delivery can be made to a wider area at a specified time, and the like. For inspection and security, the magnitude of effect may be determined based on whether suspicious persons can be detected, whether the robot can explain when nothing is wrong, whether problems can be solved quickly, whether security can be provided to many areas, and the like. For advertising, the magnitude of effect may be determined based on whether the advertisement can be seen by many people, whether the robot can visit many places, whether the robot can travel quickly to crowded places, and the like. For cleaning, the magnitude of effect may be determined based on whether the robot can clean well, whether the robot can clean quickly, whether the spots or areas to be cleaned are large, and the like. Methods that can predict the magnitude of effect to some extent in advance and can quantify the magnitude of effect to some extent will be employed.

The evaluation performed based on a combination of the priority and service effect of each service will be described.

Since the service effect varies from service to service, standardization is used to calculate the service effect. This allows the sum of the service effects and comparison of the service effects between services to be performed on the same scale.

Table 3 shows an example of each service priority and service effect.

TABLE 3

| Service | Priority | Service Effect |
|---|---|---|
| Delivery | 1.0 | Difference from scheduled delivery time |
| (Line | | 5 minutes or less = 10 |
| movement) | | −1 for each additional 5 minutes delay |
| Inspection | 1.2 | Security surface area based on patrol |
| and security | | route |
| (Surface | | Security surface area based on originally |
| movement) | | set patrol route = 10 |
| | | −1 for each reduction in security surface |
| | | area by 5% |
| Advertising | 0.8 | Advertising surface area based on |
| (Surface | | traveling route |
| movement) | | Advertising surface area based on |
| | | originally set traveling route = 10 |
| | | −1 for each reduction in advertising |
| | | surface area by 5% |
| Cleaning | 1.0 | Difference from scheduled cleaning start |
| (Line | | time |
| movement) | | 5 minutes or less = 10 |
| | | −1 for each additional 5 minutes delay |

In Table 3, the number of viewers (=foot traffic×viewing rate) may be used to calculate the service effect for advertising. The foot traffic refers to, for example, the number of pedestrians around the robot obtained by detector 21, such as a sensor. The viewing rate refers to the percentage of surrounding pedestrians looking in the direction of the robot, as obtained by detector 21.

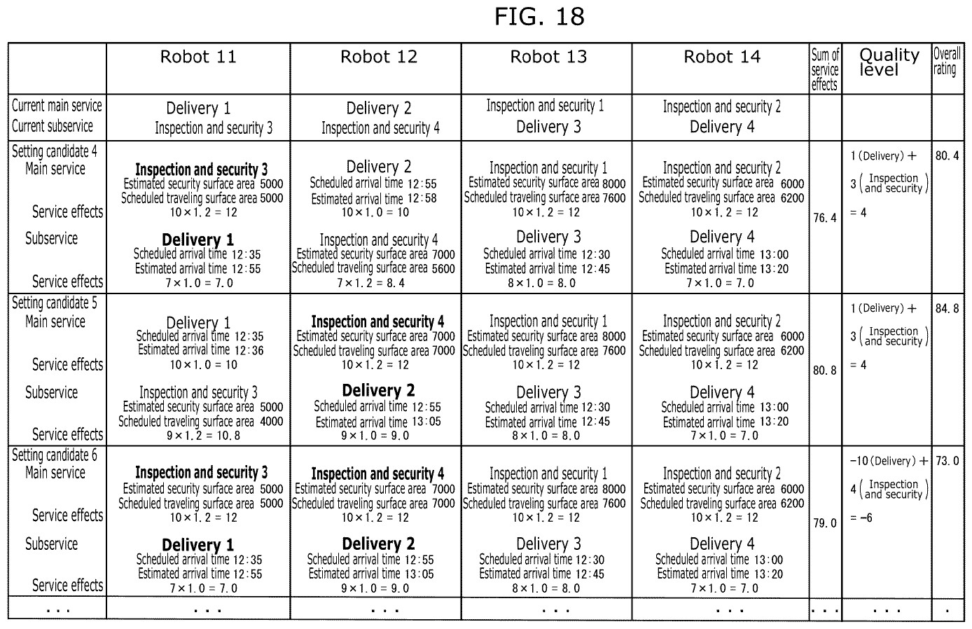

FIG. 18 illustrates an example of a selection of a robot whose service is to be changed to inspection and security.

FIG. 18 illustrates an example in which the proportion of the robots that execute the inspection and security service to the entire robots is at least 75%. The services are reassigned to each robot such that the conditions indicated here are achieved and the sum of the quality level and the service effect becomes the highest.

In the example illustrated in FIG. 18, the sum of the service effects for setting candidate 4 is 76.4, the sum of the service effects for setting candidate 5 is 80.8, and the sum of the service effects for setting candidate 6 is 79.0. In the example illustrated in FIG. 18, the quality level of setting candidate 4 is 4, the quality level of setting candidate 5 is 4, and the quality level of setting candidate 6 is −6. Moreover, FIG. 18 shows each overall rating that is the sum of the service effect and the quality level. In FIG. 18, the overall rating for setting candidate 4 is 80.4, the overall rating for setting candidate 5 is 84.8, and the overall rating for setting candidate 6 is 73.0. In this example, setting candidate 5 has the highest overall rating.

Service effects were calculated using different calculation methods for respective services. Line movements, such as delivery and cleaning, refer to time, while surface movements, such as inspection and security and advertising, refer to surface area. Regarding time, 10 was given up to when the difference from the scheduled arrival time was 5 minutes or less, and −1 was given for each additional 5 minutes delay. Regarding surface area, 10 was given up to when the difference from the assumed surface area was 5% or less, and −1 was given for each additional reduction by 5%.

The quality level was determined according to the number of robots that execute a service. For example, when the number of robots that execute a service is greater than or equal to a predetermined threshold value, the quality level is 1×the number of robots. When the number of robots that execute the service is less than the predetermined threshold value, the quality level is set to −10. The predetermined threshold value in this example is one.

### OTHER EMBODIMENTS

Although the embodiment (including variations) has been described above, the present disclosure is not limited to such an embodiment and the like.

The example has been described in which, by analyzing the robot-related information output from robot 10, information obtainer 51 obtains specific information such as the current state of robot 10, the surrounding conditions of robot 10, and the service that is currently being executed by robot 10. However, the present disclosure is not limited to such an example. For example, when robot 10 is capable of analyzing the specific information described above, the analyzed information may be received by information obtainer 51, and the analyzed information may serve as robot-related information IR.

The general and specific aspects of the present disclosure may be implemented using a system, a device, a method, an integrated circuit, a computer program, or a computer-readable recording medium such as a CD-ROM, or any combination of systems, devices, methods, integrated circuits, computer programs, and recording media.

The order of the processes described in each of the flowcharts according to the embodiment and the like described above is an example. The order of the plurality of processes may be changed or executed in parallel.

Furthermore, the separation of the function blocks in the block diagrams is merely an example, and plural function blocks may be implemented as a single function block, a single function block may be separated into plural function blocks, or part of functions of a function block may be transferred to another function block. Furthermore, the functions of function blocks having similar functions may be processed in parallel or in a time division manner by a single hardware or software.

In the embodiment described above, each structural element (for example, a processor such as a controller) may be configured in the form of a dedicated hardware product or realized by executing a software program suitable for each structural element. Each of the structural elements may be realized by means of a program executing unit, such as a central processing unit (CPU) or a processor, reading and executing the software program recorded on a recording medium, such as a hard disk or a semiconductor memory. Moreover, for example, each structural element may be a circuit (or an integrated circuit). Such circuits may form a single circuit as a whole or be separate circuits. These circuits each may be a general-purpose circuit or a dedicated circuit.

Various modifications to the present embodiment that can be conceived by those skilled in the art, and forms configured by combining the structural elements and functions in the embodiment without departing from the teachings of the present disclosure are also included in the present disclosure.

### INDUSTRIAL APPLICABILITY

The present disclosure can be widely used as a service support method that supports services executed by a plurality of robots.

1. A service support method for supporting a service executed by a plurality of robots, the service support method comprising:
calculating a switched service-quality level indicating an overall quality of a quality of a first service and a quality of a second service when the first service is switched to the second service, the first service being executed by a predetermined robot among the plurality of robots;
calculating a non-switched service-quality level indicating an overall quality of the quality of the first service and the quality of the second service when the first service executed by the predetermined robot is not switched to the second service; and
outputting switching information related to switching of the service, based on the switched service-quality level and the non-switched service-quality level.

2. The service support method according to claim 1, further comprising:
determining whether to switch the first service executed by the predetermined robot to the second service, based on the switched service-quality level and the non-switched service-quality level; and
outputting a result of the determining as the switching information.

3. The service support method according to claim 2,
wherein, in the determining, when the switched service-quality level is lower than or equal to the non-switched service-quality level, the first service executed by the predetermined robot is determined not to be switched to the second service, and
in the determining, when the switched service-quality level is higher than the non-switched service-quality level, the first service executed by the predetermined robot is determined to be switched to the second service.

4. The service support method according to claim 1,
wherein the calculating of the switched service-quality level and the calculating of the non-switched service-quality level are performed when a trigger event occurs, the trigger event triggering a determination as to whether to switch the service; and
the calculating of the switched service-quality level and the calculating of the non-switched service-quality level are not performed when the trigger event does not occur.

5. The service support method according to claim 1,
wherein each of the switched service-quality level and the non-switched service-quality level is derived based on an addition value and a deduction value,
the addition value is a sum of: a value obtained by multiplying a total number of robots that execute the first service by a first coefficient; and a value obtained by multiplying a total number of robots that execute the second service by a second coefficient, and
the deduction value is a sum of: a value that is deducted when the total number of robots that execute the first service is less than a first threshold value; and a value that is deducted when the total number of robots that execute the second service is less than a second threshold value.

6. The service support method according to claim 5,
wherein an absolute value of the value that is deducted when the total number of robots that execute the first service is less than the first threshold value is greater than the first coefficient, and
an absolute value of the value that is deducted when the total number of robots that execute the second service is less than the second threshold value is greater than the second coefficient.

7. The service support method according to claim 1, further comprising:
displaying the switching information on a monitor.

8. The service support method according to claim 1,
wherein the calculating of the switched service-quality level and the calculating of the non-switched service-quality level are performed in a predetermined area in which the predetermined robot operates.

9. The service support method according to claim 1,
wherein the calculating of the switched service-quality level and the calculating of the non-switched service-quality level are performed based on schedule information of the predetermined robot.

10. The service support method according to claim 2, further comprising:
causing an other robot that is different from the predetermined robot to execute the second service, when the first service executed by the predetermined robot is determined not to be switched to the second service, the other robot being included in the plurality of robots.

11. The service support method according to claim 2, further comprising:
switching the first service executed by the predetermined robot to the second service after causing an other robot that is different from the predetermined robot to execute the first service when the first service executed by the predetermined robot is determined to be switched to the second service, the other robot being included in the plurality of robots.

12. The service support method according to claim 2, further comprising:
switching the first service executed by the predetermined robot to the second service after causing an other robot that is different from the predetermined robot to temporarily execute the second service, when the first service executed by the predetermined robot is determined to be switched to the second service, the other robot being included in the plurality of robots.

13. A service support device that supports a service executed by a plurality of robots, the service support device comprising:
a quality level calculator that calculates:
a switched service-quality level indicating an overall quality of a quality of a first service and a quality of a second service when the first service is switched to the second service, the first service being executed by a predetermined robot among the plurality of robots; and
a non-switched service-quality level indicating an overall quality of the quality of the first service and the quality of the second service when the first service executed by the predetermined robot is not switched to the second service; and
a switching information outputter that outputs switching information related to switching of the service, based on the switched service-quality level and the non-switched service-quality level.

14. A robot that is the predetermined robot that communicates with the service support device according to claim 13, the robot operating based on the switching information output from the service support device.

15. A non-transitory computer-readable recording medium having recorded thereon a program for causing a computer to execute the service support method according to claim 1.
